(19) United States
(12) Patent Application Publication
(10) Pub. No.: US 2025/0282230 A1
(43) Pub. Date: Sep. 11, 2025

(54) Solar Powered Universal Car Covers Device

(71) Applicants: Bruce Baum, Santa Fe Springs, CA (US); Phillip Baum, Santa Fe Springs, CA (US)

(72) Inventors: Bruce Baum, Santa Fe Springs, CA (US); Phillip Baum, Santa Fe Springs, CA (US)

(21) Appl. No.: 18/808,280

(22) Filed: Aug. 19, 2024

Related U.S. Application Data
(60) Provisional application No. 63/563,623, filed on Mar. 11, 2024.

(51) Int. Cl. B60L 8/00; H02S 40/00

(52) U.S. Cl. CPC B60L 8/003; H02S 40/00

(57) ABSTRACT

A solar powered car cover device is disclosed which is a solar powered car cover for electric vehicles. The solar powered car cover device comprises a plurality of solar panels with a universal adapter. The plurality of solar panels are connected in series and roll out from the top of a vehicle and directly connect to the vehicle via the universal adapter. Thus, the user will have the ability to supply power to their vehicle using solar power from the solar panels. The device can be universal or specifically made for each vehicle make and model. Accordingly, users can park their vehicle and obtain supplemental charge for their vehicle batteries via the device.

### CROSS-REFERENCE TO RELATED APPLICATION

The present application claims priority to, and the benefit of, U.S. Provisional Application No. 63/563,623, which was filed on Mar. 11, 2024, and is incorporated herein by reference in its entirety.

### FIELD OF THE INVENTION

The present invention relates generally to the field of solar powered car cover devices. More specifically, the present invention relates to a solar powered vehicle cover with a universal adapter designed to accommodate any residential or commercial vehicle. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in solar powered car cover devices. Generally, people who own electric vehicles may be unable to travel long distances due to lack of charge capacity. Further, roads must be traveled where charging stations are prevalent. Additionally, paying for electricity at charging stations can be expensive and lead to a significant increase in expenses.

Furthermore, the increased use of electric powered vehicles has caused an increased need for charging the vehicles. In an electric powered vehicle, a series of storage batteries are mounted within the vehicle for providing the electricity needed to energize an electric motor connected to the drive train of the vehicle. A large number of storage batteries are typically employed to provide sufficient electricity to propel the vehicle over a wide range before requiring recharging. Previously devised electric powered vehicles are typically recharged by connecting the batteries through a suitable recharging device to a source of electrical energy such as the electrical circuit in a building or residential home. During recharging, which can take several hours, the vehicle is completely inoperative.

Previously constructed batteries are typically heavy and are required in large numbers in order to provide an adequate driving range between recharging periods. Furthermore, such batteries still utilize electricity generated by the conventional means, such as fossil fuels, hydro, nuclear, etc., which adds to the expense of recharging the batteries and further inhibits the rapid deployment of large numbers of electric powered vehicles. In an attempt to overcome the aforementioned problems, another means for charging electric vehicles is needed. The present invention discloses utilizing solar panels mounted on vehicles to partially recharge the batteries during the operation of the vehicle, so as to increase the operating range of the vehicle and to decrease battery recharging time.

Accordingly, there is a demand for an improved solar powered car cover device that provides users with a solar powered vehicle cover for charging. More particularly, there is a demand for a solar powered car cover device that provides a way to maintain a supplemental charge to their vehicle battery.

Therefore, there exists a long felt need in the art for a solar powered car cover device that provides users with a solar powered vehicle cover with a universal adapter designed to accommodate any residential or commercial vehicle. There is also a long felt need in the art for a solar powered car cover device that automatically rolls out from the top of the vehicle once the driver stops and parks their car, truck, SUV, etc. Further, there is a long felt need in the art for a solar powered car cover device that allows users to choose a cover and a pig tail adapter specifically made to fit their vehicle for charging. Moreover, there is a long felt need in the art for a device that offers a way for electric vehicle owners to maintain supplemental charge to their vehicle battery without having to constantly stop and locate charging stations. Further, there is a long felt need in the art for a solar powered car cover device that can be universal or specifically made for each vehicle make and model. Finally, there is a long felt need in the art for a solar powered car cover device that is useful during natural disasters and power outages.

The subject matter disclosed and claimed herein, in one embodiment thereof, comprises a solar powered car cover device. The device is a solar powered car cover for electric vehicles. The solar powered car cover device comprises a plurality of solar panels with a universal adapter. The plurality of solar panels are connected in series and roll out from the top of a vehicle and directly connect to the vehicle via the universal adapter. Thus, the user will have the ability to supply power to their vehicle using solar power from the solar panels. The device can be universal or specifically made for each vehicle make and model. Accordingly, users can park their vehicle and obtain supplemental charge for their vehicle batteries via the device.

In this manner, the solar powered car cover device of the present invention accomplishes all of the forgoing objectives and provides users with a device that charges electric vehicles via a car cover. The device is a plurality of solar panels with a universal adapter. The device can be used during natural disasters or other power outages.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar powered car cover device for electric vehicles. The solar powered car cover device comprises a plurality of solar panels with a universal adapter to directly connect to the vehicle. Once in position, the user will have the ability to supply power to their vehicle using solar power from the solar panels. Accordingly, users can park their vehicle and obtain supplemental charge for their vehicle batteries via the device.

In one embodiment, the solar powered car cover device can be utilized with any conventional electric vehicle as is known in the art. Typically, the electric vehicle is a conventional electric powered vehicle having an electric motor mounted therein which is connected to the vehicle drive train for propelling the vehicle. The electric motor receives electrical energy from a plurality of parallel connected storage batteries which are mounted within the vehicle. The storage batteries may be recharged by connection through a conventional battery recharger to a suitable source of electrical energy, such as an electrical outlet connected to the electrical circuit within a building or residential home.

In one embodiment, the vehicle is an electric vehicle that runs off a battery pack stored on the lower portion of the vehicle. In another embodiment the vehicle may be hybrid-gasoline vehicle or a fuel-cell powered vehicle or any combination thereof.

In one embodiment, the solar powered car cover device comprises a plurality of solar panels. The solar panels are operative to convert incident solar radiation into electrical energy. The solar panels are mounted on the electric vehicle and are electrically connected to the storage batteries via a universal adapter or other suitable connecting means and are operative to supply electrical current thereto for recharging the batteries. The solar panels are identically constructed and only differ in size, so as to conform the solar panels to the size and configuration of the exterior surface on the vehicle on which it is mounted.

In one embodiment, a universal adapter is used to connect to an electric vehicle battery. The universal adapter allows the device to be universal and connected and applied to any suitable electric vehicle as is known in the art. In another embodiment, the adapter can be a pig tail adapter and specifically made for each electric vehicle make and model.

In one embodiment, the solar panels are conventional solar panels and are operative to convert solar radiation incident thereon into electrical energy. Each solar panel comprises a series of photovoltaic cells which are arranged in a thin layer. As is commonly known, a photovoltaic cell is formed of an amorphous semi-conductor material, such as silicon. As the interconnection of the individual cells is well known and is not germane to the present invention, details of such interconnection will not be described herein. It will be understood, however, that such individual photovoltaic cells are interconnected, so as to provide through a common output cable a constant flow of electrical energy.

In one embodiment, the solar panels are electrically connected through a voltage regulator to the storage batteries via the universal adapter. The batteries, as is conventional, are electrically connected to an electric motor which, when energized, propels the vehicle.

In one embodiment, the storage batteries may also be connected through a suitable plug mounted on the vehicle to an alternate source of electrical energy, such as the electrical power circuit within a building or a residential house for recharging the batteries when the vehicle is not in use. In this configuration, the solar panels act as a supplemental source of energy for the storage batteries, which extends the driving range of the vehicle and reduces the recharging time for the storage batteries.

In one embodiment, the plurality of solar panels are connected in series to form a solar panel cover which covers the top and sides of a vehicle during use. Any suitable number of solar panels can be utilized to form the solar panel cover, depending on the shape and size of the vehicle to which it is to be applied. Further, the solar panels can be any suitable shape and size, as needed.

In one embodiment, the solar panel cover comprises solar electric cells that are electrically connected to a photovoltaic charging system and battery via the universal adapter. In one embodiment, the battery is the vehicle battery that powers the vehicle, which in one embodiment may be an electric vehicle. When the solar panel cover is deployed to cover the top of the vehicle and the solar electric cells are facing the sun, the battery within the electric vehicle can be charged by the solar electric cells.

In one embodiment, the plurality of solar panels are attached in series to form a cover for the top and sides of the vehicle. Typically, the plurality of solar panels are connected to one another through a flexible and water-tight linkage. In one embodiment, at each end of the solar panels positioned at the perimeter is one or more rollers configured to fit within a set of “U” or “V” shaped tracks mounted to the top and sides of the vehicle. As the electric motor that extracts or retracts the cover is engaged, the rollers attached to each solar panel roll along the interior of the track to cover the top and sides of the vehicle.

In one embodiment, the edges of the solar panels positioned at the perimeter, comprise the one or more rollers which slide along parallel tracks running down the sides of the vehicle, between the front and rear of the vehicle, and then along the bottom edges of the vehicle. As the plurality of solar panels are extended and retracted the rollers are guided along these tracks from the upper portion of the vehicle down toward a bottom of the vehicle. Thus, the tracks automatically allow the solar panels to open and retract over the vehicle at the touch of a button, all other components for attachment will be on a specialized dolly stored inside the vehicle.

In one embodiment, the solar panel cover is retracted or expanded via a motor, having a pair of outwardly extending output shafts. The motor may constitute an electric motor which is connected to the vehicle batteries for power. The motor is mounted in a sealed housing which is situated at the rear of one or more solar panels. The motor is positioned such that the output shafts extend transversely across the vehicle. The outward ends of the output shafts are operably coupled to the solar panels. Rotation of the output shafts of the motor is converted to expand and retract the solar panels.

In one embodiment, the solar panel cover can be retracted completely into the top of the vehicle, so as to be stored completely on the roof or within a structure disposed on the ceiling of the vehicle.

In one embodiment, the motor can rotate clockwise and counterclockwise at a desired speed. It should be realized that many different mechanisms could be used to open and close the solar panel cover. Further, when the motor turns in one direction, the solar panel cover is pushed out of the opening and unwound as it moves from the top of the vehicle towards the bottom. When the motor turns in the opposite direction, the solar panel cover is pulled back into its stored position on the roof or within the ceiling.

In one embodiment, to open or close the solar panel cover, a user may press an activation button within or outside of the vehicle. In an alternate embodiment, the vehicle may have wireless access, and the solar panel cover may be opened or closed using a wireless device, such as a cellular telephone, which can be used to access an application program configured to control the movement of the solar panel cover. In another embodiment, the vehicle may include a display screen having a user interface with a programmed button that can be activated by touch detection to control the movement of the solar panel cover from an open to a closed position.

In one embodiment, the solar panel cover can be manually positioned on the top and sides of a vehicle via a user and mounted or secured via tie-downs, screws, adhesives, etc., or any other suitable securing means as is known in the art. Further, it should be realized that many different mechanisms could be used to employ the solar panel cover on an electric vehicle, as is known in the art.

In one embodiment, the solar powered car cover device provides an increased solar radiation collection surface area which generates added amounts of electrical energy for recharging the storage batteries in an electric vehicle. This not only extends the driving range of the vehicle but substantially reduces the recharging time of the batteries when the batteries are connected to an alternate source of electrical energy, such as the electrical circuit in a building or a residential home.

In yet another embodiment, the solar powered car cover device comprises a plurality of indicia.

In yet another embodiment, a method of charging an electric vehicle via a plurality of solar panels is disclosed. The method includes the steps of providing a solar powered car cover device comprising a plurality of solar panels with a universal adapter. The method also comprises securing the plurality of solar panels together in a series. Further, the method comprises extracting the plurality of solar panels from a top of the vehicle. The method also comprises connecting the universal adapter to the vehicle's battery to be charged. Finally, the method comprises charging the electric vehicle via solar energy captured from the plurality of solar panels.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the solar powered car cover device of the present invention showing the device in use on an electric vehicle in accordance with the disclosed architecture;

FIG. 2 illustrates a perspective view of one embodiment of the solar powered car cover device of the present invention showing the device installed on different types of electric vehicles in accordance with the disclosed architecture;

FIG. 3 illustrates a perspective view of one embodiment of the solar powered car cover device of the present invention showing the solar panels expanding from the top of the vehicle in accordance with the disclosed architecture;

FIG. 4 illustrates a perspective view of one embodiment of the solar powered car cover device of the present invention showing the solar panels retracting from the vehicle in accordance with the disclosed architecture;

FIG. 5 illustrates a perspective view of one embodiment of the solar powered car cover device of the present invention showing the solar panels completely expanded during use in accordance with the disclosed architecture; and

FIG. 6 illustrates a flowchart showing the method of charging an electric vehicle via a plurality of solar panels in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a solar powered car cover device that provides users with a solar powered vehicle cover with a universal adapter designed to accommodate any residential or commercial vehicle. There is also a long felt need in the art for a solar powered car cover device that automatically rolls out from the top of the vehicle once the driver stops and parks their car, truck, SUV, etc. Further, there is a long felt need in the art for a solar powered car cover device that allows users to choose a cover and a pig tail adapter specifically made to fit their vehicle for charging. Moreover, there is a long felt need in the art for a device that offers a way for electric vehicle owners to maintain supplemental charge to their vehicle battery without having to constantly stop and locate charging stations. Further, there is a long felt need in the art for a solar powered car cover device that can be universal or specifically made for each vehicle make and model. Finally, there is a long felt need in the art for a solar powered car cover device that is useful during natural disasters and power outages.

The present invention, in one exemplary embodiment, is a novel solar powered car cover device. The solar powered car cover device comprises a plurality of solar panels with a universal adapter. The plurality of solar panels are connected in series and roll out from the top of a vehicle and directly connect to the vehicle via the universal adapter. Thus, the user will have the ability to supply power to their vehicle using solar power from the solar panels. The device can be universal or specifically made for each vehicle make and model. Accordingly, users can park their vehicle and obtain supplemental charge for their vehicle batteries via the device. The present invention also includes a novel method of charging an electric vehicle via a plurality of solar panels. The method includes the steps of providing a solar powered car cover device comprising a plurality of solar panels with a universal adapter. The method also comprises securing the plurality of solar panels together in a series. Further, the method comprises extracting the plurality of solar panels from a top of the vehicle. The method also comprises connecting the universal adapter to the vehicle's battery to be charged. Finally, the method comprises charging the electric vehicle via solar energy captured from the plurality of solar panels.

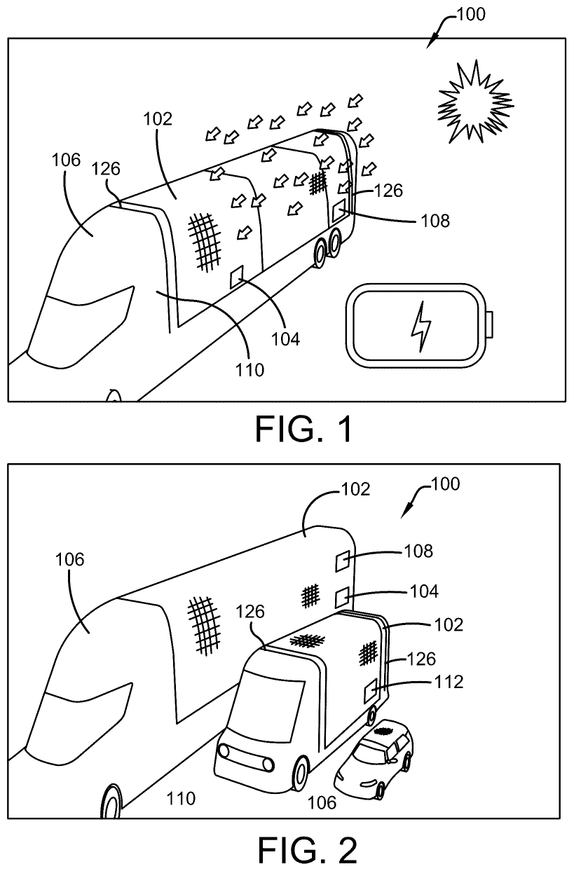

Referring initially to the drawings, FIG. 1 illustrates a perspective view of one embodiment of the solar powered car cover device 100 of the present invention. In the present embodiment, the solar powered car cover device 100 is an improved solar powered car cover device 100 that provides a user with a car cover for electric vehicles 106. Specifically, the solar powered car cover device 100 comprises a plurality of solar panels 102 and an universal adapter 104 to directly connect to the vehicle 106. Once in position, the user will have the ability to supply power to their vehicle 106 using solar power from the solar panels 102. Accordingly, users can park their vehicle 106 and obtain supplemental charge for their vehicle batteries via the device 100.

As shown in FIG. 2, the solar powered car cover device 100 can be utilized with any conventional electric vehicle 106 as is known in the art. Typically, the electric vehicle 106 is a conventional electric powered vehicle having an electric motor mounted therein which is connected to the vehicle drive train for propelling the vehicle 106. The electric motor receives electrical energy from a plurality of parallel connected storage batteries 108 which are mounted within the vehicle 106. The storage batteries 108 may be recharged by connection through a conventional battery recharger to a suitable source of electrical energy, such as an electrical outlet connected to the electrical circuit within a building or residential home.

In one embodiment, the vehicle 106 is an electric vehicle that runs off a battery pack stored on the lower portion of the vehicle 106. In another embodiment the vehicle 106 may be hybrid-gasoline vehicle or a fuel-cell powered vehicle or any combination thereof.

Furthermore, the solar powered car cover device 100 comprises a plurality of solar panels 102. The solar panels 102 are operative to convert incident solar radiation into electrical energy. The solar panels 102 are mounted on the electric vehicle 106 and are electrically connected to the storage batteries 108 via a universal adapter 104 or other suitable connecting means and are operative to supply electrical current thereto for recharging the batteries 108. The solar panels 102 are identically constructed and only differ in size, so as to conform the solar panels 102 to the size and configuration of the exterior surface 110 on the vehicle 106 on which it is mounted.

Generally, the solar panels 102 are conventional solar panels and are operative to convert solar radiation incident thereon into electrical energy. Each solar panel 102 comprises a series of photovoltaic cells which are arranged in a thin layer. As is commonly known, a photovoltaic cell is formed of an amorphous semi-conductor material, such as silicon. As the interconnection of the individual cells is well known and is not germane to the present invention, details of such interconnection will not be described herein. It will be understood, however, that such individual photovoltaic cells are interconnected, so as to provide through a common output cable a constant flow of electrical energy.

Typically, the solar panels 102 are electrically connected through a voltage regulator to the storage batteries 108 via the universal adapter 104. The batteries 108, as is conventional, are electrically connected to an electric motor which, when energized, propels the vehicle 106. Specifically, the universal adapter 104 is used to connect to an electric vehicle battery 108. The universal adapter 104 allows the device 100 to be universal and connected and applied to any suitable electric vehicle 106 as is known in the art. In another embodiment, the adapter can be a pig tail adapter 112 or other suitable adapter, which is specifically made for each electric vehicle 106 make and model.

Further, the storage batteries 108 may also be connected through a suitable plug mounted on the vehicle 106 to an alternate source of electrical energy, such as the electrical power circuit within a building or a residential house for recharging the batteries 108 when the vehicle 106 is not in use. In this configuration, the solar panels 102 act as a supplemental source of energy for the storage batteries 108, which extends the driving range of the vehicle 106 and reduces the recharging time for the storage batteries 108.

In yet another embodiment, the solar powered car cover device 100 comprises a plurality of indicia 140. The solar panels 102 of the device 100 may include advertising, a trademark, or other letters, designs, or characters, printed, painted, stamped, or integrated into the solar panels 102, or any other indicia 140 as is known in the art. Specifically, any suitable indicia 140 as is known in the art can be included, such as but not limited to, patterns, logos, emblems, images, symbols, designs, letters, words, characters, animals, advertisements, brands, etc., that may or may not be solar panel, electric vehicle, or brand related.

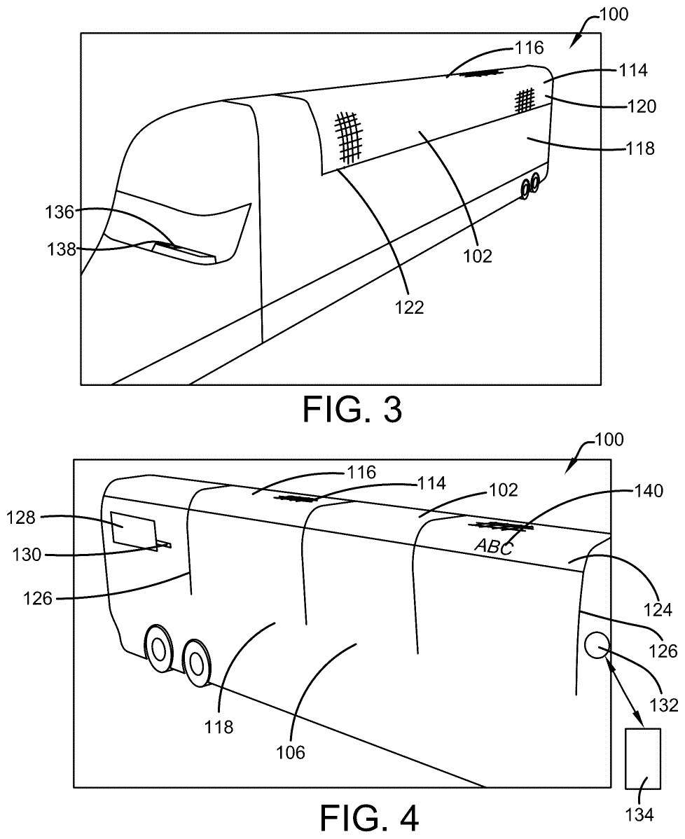

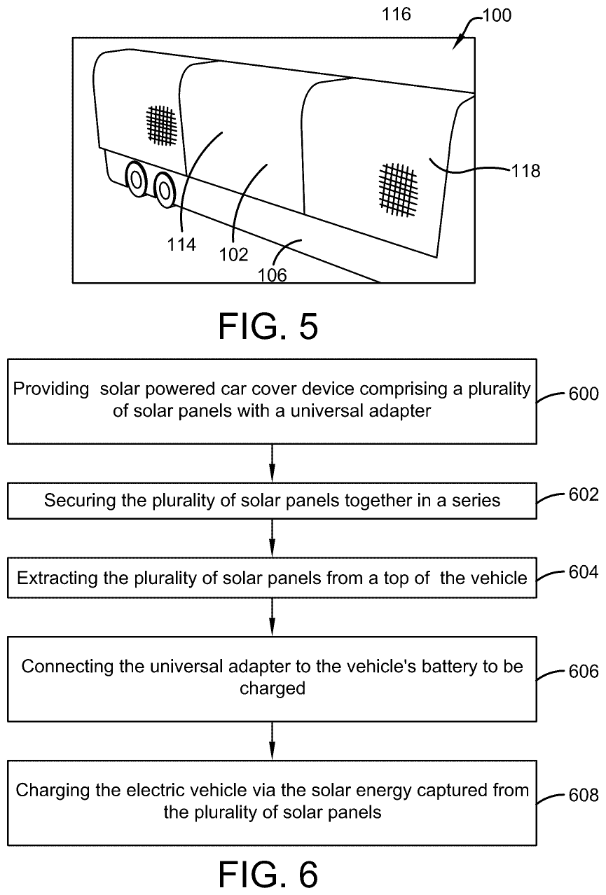

As shown in FIGS. 3-5, the plurality of solar panels 102 are connected in series to form a solar panel cover 114 which covers the top 116 and sides 118 of a vehicle 106 during use. Any suitable number of solar panels 102 can be utilized to form the solar panel cover 114, depending on the shape and size of the vehicle 106 to which it is to be applied. Further, the solar panels 102 can be any suitable shape and size, as needed.

Furthermore, the solar panel cover 114 comprises solar electric cells that are electrically connected to a photovoltaic charging system and battery 108 via the universal adapter 104. In one embodiment, the battery 108 is the vehicle battery that powers the vehicle 106, which in one embodiment may be an electric vehicle. When the solar panel cover 114 is deployed to cover the top 116 of the vehicle 106 and the solar electric cells are facing the sun, the battery 108 within the electric vehicle 106 can be charged by the solar electric cells.

Additionally, the plurality of solar panels 102 are attached in series to form a cover 114 for the top 116 and sides 118 of the vehicle 106. Typically, the plurality of solar panels 102 are connected to one another through a flexible and water-tight linkage 120. In one embodiment, at each end 122 of the solar panels 102 positioned at the perimeter is one or more rollers 124 configured to fit within a set of “U” or “V” shaped tracks 126 mounted to the top 116 and sides 118 of the vehicle 106. As the electric motor 128 that extracts or retracts the cover 114 is engaged, the rollers 124 attached to each solar panel 102 roll along the interior of the track 126 to cover the top 116 and sides 118 of the vehicle 106. Thus, the tracks 126 automatically allow the solar panels (i.e., cover 114) to open and retract over the vehicle 106 at the touch of a button 132, all other components for attachment will be on a specialized dolly stored inside the vehicle 106.

Further, the edges 122 of the solar panels 102 positioned at the perimeter, comprise the one or more rollers 124 which slide along parallel tracks 126 running down the sides 118 of the vehicle 106, between the front and rear of the vehicle 106, and then along the bottom edges of the vehicle 106. As the plurality of solar panels 102 are extended and retracted the rollers 124 are guided along these tracks 126 from the upper portion of the vehicle 106 down toward a bottom of the vehicle 106.

Typically, the solar panel cover 114 is retracted or expanded via a motor 128, having a pair of outwardly extending output shafts 130. The motor 128 may constitute an electric motor which is connected to the vehicle batteries 108 for power. The motor 128 is mounted in a sealed housing which is situated at the rear of one or more solar panels 102. The motor 128 is positioned such that the output shafts 130 extend transversely across the vehicle 106. The outward ends of the output shafts 130 are operably coupled to the solar panels 102. Rotation of the output shafts 130 of the motor 128 is converted to expand and retract the solar panels 102.

In one embodiment, the solar panel cover 114 can be retracted completely into the top 116 of the vehicle 106, so as to be stored completely on the roof or within a structure disposed on the ceiling of the vehicle 106.

Further, the motor 128 can rotate clockwise and counterclockwise at a desired speed. It should be realized that many different mechanisms could be used to open and close the solar panel cover 114. Further, when the motor 128 turns in one direction, the solar panel cover 114 is pushed out of the opening and unwound as it moves from the top 116 of the vehicle 106 towards the bottom. When the motor 128 turns in the opposite direction, the solar panel cover 114 is pulled back into its stored position on the roof or within the ceiling.

In one embodiment, to open or close the solar panel cover 114, a user may press an activation button 132 within or outside of the vehicle 106. In an alternate embodiment, the vehicle 106 may have wireless access, and the solar panel cover 114 may be opened or closed using a wireless device 134, such as a cellular telephone, which can be used to access an application program configured to control the movement of the solar panel cover 114. In another embodiment, the vehicle 106 may include a display screen 136 having a user interface with a programmed button 138 that can be activated by touch detection to control the movement of the solar panel cover 114 from an open to a closed position.

In one embodiment, the solar panel cover 114 can be manually positioned on the top 116 and sides 118 of a vehicle 106 via a user and mounted or secured via tie-downs, screws, adhesives, etc., or any other suitable securing means as is known in the art. Further, it should be realized that many different mechanisms could be used to employ the solar panel cover 114 on an electric vehicle 106, as is known in the art.

Accordingly, the solar powered car cover device 100 provides an increased solar radiation collection surface area which generates added amounts of electrical energy for recharging the storage batteries 108 in an electric vehicle 106. This not only extends the driving range of the vehicle 106 but substantially reduces the recharging time of the batteries 108 when the batteries 108 are connected to an alternate source of electrical energy, such as the electrical circuit in a building or a residential home.

FIG. 6 illustrates a flowchart of the method of charging an electric vehicle via a plurality of solar panels. The method includes the steps of at 600, providing a solar powered car cover device comprising a plurality of solar panels with a universal adapter. The method also comprises at 602, securing the plurality of solar panels together in a series. Further, the method comprises at 604, extracting the plurality of solar panels from a top of the vehicle. The method also comprises at 606, connecting the universal adapter to the vehicle's battery to be charged. Finally, the method comprises at 608, charging the electric vehicle via solar energy captured from the plurality of solar panels.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “solar powered car cover device”, “solar powered device”, “car cover device”, and “device” are interchangeable and refer to the solar powered car cover device 100 of the present invention.

Notwithstanding the forgoing, the solar powered car cover device 100 of the present invention can be of any suitable size and configuration as is known in the art without affecting the overall concept of the invention, provided that it accomplishes the above stated objectives. One of ordinary skill in the art will appreciate that the solar powered car cover device 100 as shown in FIGS. 1-6 is for illustrative purposes only, and that many other sizes and shapes of the solar powered car cover device 100 are well within the scope of the present disclosure. Although the dimensions of the solar powered car cover device 100 are important design parameters for user convenience, the solar powered car cover device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar powered car cover device that provides a charging car cover for an electric vehicle, the solar powered car cover device comprising:
a plurality of solar panels; and
an universal adapter;
wherein the universal adapter directly connects the plurality of solar panels to an electric vehicle; and
further wherein the plurality of solar panels are positioned on a top of the electric vehicle and act to supply supplemental charge to batteries of the electric vehicle.

2. The solar powered car cover device of claim 1, wherein the electric vehicle is typically a conventional electric powered vehicle having an electric motor mounted therein which is connected to a vehicle drive train for propelling the electric vehicle, and typically the electric motor receives electrical energy from a plurality of parallel connected storage batteries which are mounted within the electric vehicle.

3. The solar powered car cover device of claim 2, wherein the parallel connected storage batteries may be recharged by connection through a conventional battery recharger to a suitable source of electrical energy, such as an electrical outlet connected to an electrical circuit within a building or residential home.

4. The solar powered car cover device of claim 3, wherein the plurality of solar panels are operative to convert incident solar radiation into electrical energy.

5. The solar powered car cover device of claim 4, wherein the plurality of solar panels are mounted on the electric vehicle and are electrically connected to the storage batteries via the universal adapter.

6. The solar powered car cover device of claim 5, wherein a pig tail adapter is utilized to connect to the storage batteries, which is specifically made for a specific electric vehicle.

7. The solar powered car cover device of claim 6 further comprising a plurality of indicia.

8. The solar powered car cover device of claim 7, wherein the plurality of solar panels are connected in series to form a solar panel cover which covers a top and sides of the electric vehicle.

9. The solar powered car cover device of claim 8, wherein the plurality of solar panels are connected to one another through a flexible and water-tight linkage.

10. The solar powered car cover device of claim 9, wherein at each end of solar panels positioned at a perimeter of the solar panel cover is at least one roller configured to fit within a set of parallel tracks mounted to the top and sides of the electric vehicle.

11. The solar powered car cover device of claim 10, wherein the at least one roller slides along the set of parallel tracks which run down the sides of the electric vehicle, between a front and a rear of the electric vehicle.

12. The solar powered car cover device of claim 11, wherein an electric motor engages the at least one roller to expand and retract the solar panel cover.

13. A solar powered car cover device that provides a charging car cover for an electric vehicle, the solar powered car cover device comprising:
a plurality of solar panels; and
an universal adapter;
wherein the plurality of solar panels are operative to convert incident solar radiation into electrical energy;
wherein the plurality of solar panels are mounted on the electric vehicle and are electrically connected to batteries via the universal adapter;
wherein the plurality of solar panels are connected in series through a flexible and water-tight linkage to form a solar panel cover which covers a top and sides of the electric vehicle;
wherein at each end of solar panels positioned at a perimeter of the solar panel cover is at least one roller configured to fit within a set of parallel tracks mounted to the top and sides of the electric vehicle;
wherein the at least one roller slides along the set of parallel tracks which run down the sides of the electric vehicle, between a front and a rear of the electric vehicle; and
further wherein a motor engages the at least one roller to expand and retract the solar panel cover.

14. The solar powered car cover device of claim 13, wherein the motor is an electric motor which is connected to the vehicle batteries for power.

15. The solar powered car cover device of claim 14, wherein the motor comprises output shafts, which are operably coupled to the solar panels, such that rotation of the output shafts is converted to expand and retract the solar panel cover.

16. The solar powered car cover device of claim 15, wherein the solar panel cover can be retracted completely into the top of the vehicle.

17. The solar powered car cover device of claim 16, wherein when the motor turns in one direction, the solar panel cover is pushed out of the top of the vehicle and unwound as it moves from the top of the vehicle towards the bottom, and when the motor turns in an opposite direction, the solar panel cover is pulled back into its stored position on the top of the vehicle.

18. The solar powered car cover device of claim 13, wherein to open or close the solar panel cover, a user may press an activation button on the electric vehicle or use a display screen with a programmed button.

19. The solar powered car cover device of claim 13, wherein the solar panel cover is manually positioned on the top and sides of a vehicle via a user and secured in place.

20. A method of charging an electric vehicle via a plurality of solar panels, the method comprising the following steps:
providing a solar powered car cover device comprising a plurality of solar panels with a universal adapter;
securing the plurality of solar panels together in a series;
extracting the plurality of solar panels from a top of the vehicle;
connecting the universal adapter to the vehicle's battery to be charged; and
charging the electric vehicle via solar energy captured from the plurality of solar panels.
